(19) United States
(12) Patent Application Publication
(10) Pub. No.: US 2015/0064003 A1
(43) Pub. Date: Mar. 5, 2015

(54) AIRFLOW MODIFYING ELEMENT FOR SUPPRESSING AIRFLOW NOISE

(71) Applicant: General Electric Company, Schenectady, NY (US)

(72) Inventor: Roger Drobietz, Rheine (DE)

(73) Assignee: General Electric Company, Schenectady, NY (US)

(21) Appl. No.: 14/010,628

(22) Filed: Aug. 27, 2013

(51) Int. Cl. F03D 1/06; F03D 7/04; F03D 7/02

(52) U.S. Cl. CPC F03D 1/0641; F03D 7/022; F03D 7/042
USPC 416/1; 416/236 R; 416/23

(57) ABSTRACT

A rotor blade assembly is provided having an airflow modifying element for suppressing airflow noise caused by a drain hole. The rotor blade assembly includes at least one rotor blade including a body shell extending between a blade root and a blade tip. Further, the rotor blade includes at least one drain hole having a diameter. The drain hole is configured within the body shell of the rotor blade. At least one airflow modifying element is configured on the body shell a predetermined distance from the drain hole such that the airflow modifying element reduces airflow noise caused by the drain hole. In one embodiment, the predetermined distance is substantially equal to the diameter of the drain hole.

### FIELD OF THE INVENTION

The present invention relates generally to the field of wind turbines, and more particularly to a rotor blade assembly for a wind turbine having airflow modifying elements for suppressing airflow noise.

### BACKGROUND OF THE INVENTION

Wind turbine rotor blades are the primary elements of wind turbines for converting wind energy into electrical energy. The working principle of the blades resembles that of an airplane wing. The blades have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is geared to a generator for producing electricity.

Some rotor blades may include one or more drain holes used for draining water that may become trapped within the rotor blade during operation. The drain holes are typically located in body shell of the rotor blade, in either the pressure or suction sides, as well as side edges near the blade tip. Such drain holes, however, may cause noise or whistling in surrounding areas due to the interaction of a moving mass (e.g. air inside the drain hole) with a shear layer at the opening of the drain hole. More specifically, the moving mass may cause shear layer instabilities that, in return, amplify the movement of the mass.

It is known in the art to change the aerodynamic characteristics of wind turbine blades by adding dimples, protrusions, or other airflow modifying elements on the surface of the blade. These structures are often referred to as “vortex generators” or “vortex elements” and serve to create local regions of turbulent airflow over the surface of the blade. Conventional vortex generators are typically sheet metal and defined as “fins” or shaped structures on the suction side of the turbine blade.

As such, the industry would benefit from a rotor blade design that reduced drain-hole noise and/or whistling. More specifically, the industry would benefit from a rotor blade assembly having airflow modifying element that reduces drain-hole noise and/or whistling.

### BRIEF DESCRIPTION OF THE INVENTION

Aspects and advantages of the invention will be set forth in part in the following description, or may be obvious from the description, or may be learned through practice of the invention.

In accordance with aspects of the invention, a rotor blade assembly is provided having at least one rotor blade including a body shell extending between a blade root and a blade tip. The body shell has a pressure side surface and a suction side surface. The rotor blade includes at least one drain hole having a diameter. The drain hole is configured on the body shell of the rotor blade. At least one airflow modifying element is configured on the body shell a predetermined distance from the drain hole such that the airflow modifying element reduces airflow noise caused by the drain hole. In addition, the predetermined distance is substantially equal to the diameter of the drain hole.

In a further aspect, another embodiment of a rotor blade assembly for a wind turbine is disclosed. The rotor blade assembly includes a rotor blade having a suction side surface and a pressure side surface. Further, the rotor blade assembly includes a drain hole configured on the pressure side surface. At least one airflow modifying element is configured on the pressure side surface. The airflow modifying element is located a predetermined distance from the drain hole such that the airflow modifying element reduces airflow noise caused by the drain hole. In addition, the airflow modifying element extends a perpendicular distance from the surface of the blade to define a maximum height, the maximum height being a function of a boundary layer thickness.

In still another aspect, a method for reducing airflow noise caused by a drain hole of a wind turbine is disclosed. The method includes measuring an airflow noise near a wind turbine using a sensor; providing the airflow noise to a controller; and, actuating an airflow modifying element, by the controller, when the airflow noise exceeds a predetermined threshold. The airflow modifying element is located a predetermined distance from the drain hole. Further, the predetermined distance is equal to or less than the diameter of the drain hole. Moreover, the airflow modifying element reduces the airflow noise caused by the drain hole when the airflow modifying element is in an actuated position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art is set forth in the specification, which makes reference to the appended figures, in which:

FIG. 1 is a perspective view of a conventional wind turbine;

FIG. 2 is a perspective view of an embodiment of a rotor blade assembly in accordance with aspects of the invention;

FIG. 3 is side view of a rotor blade rotor blade assembly in accordance with aspects of the invention;

FIG. 4 is an enlarged view of the rotor blade assembly of FIG. 3;

FIG. 5 is an enlarged view of another embodiment of a rotor blade assembly in accordance with aspects of the invention; and,

FIG. 6 is another enlarged view of an alternative embodiment of a rotor blade assembly in accordance with aspects of the invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention include such modifications and variations as come within the scope of the appended claims and their equivalents.

The present invention is described herein as it may relate to a component of a wind turbine blade. It should be appreciated, however, that the unique airflow modifying element configuration in accordance with principles of the invention is not limited to use on wind turbine blades, but is applicable to any type of airfoil or flow surface that would benefit from the airflow modifying elements. Examples of such surfaces include airplane wings, boat hulls, sails, and so forth.

Generally, the present invention relates to a rotor blade assembly and method for reducing drain hole whistling. The rotor blade assembly includes a rotor blade including a body shell that extends from a blade root to a blade tip. The body shell includes a pressure side surface and suction side surface. At least one drain hole is configured on the body shell, on either or both of the suction or pressure side or a tip edge surface. An airflow modifying element is configured on the same surface as the at least one drain hole. As such, the airflow modifying element is designed to have a specific shape and location so as to reduce airflow noise caused by the drain hole, such as whistling. More specifically, the airflow modifying element enhances mixing of higher energetic flows in an outer boundary layer with lower energetic flows in an inner boundary layer and forms two counter-rotating vortices which are oriented in the flow direction. Such vortices flow over the drain hole opening and stabilize the shear layer at the opening of the drain hole. Accordingly, the resonating interaction of the mass within the drain hole (e.g. water within the blade) with the shear layer at the opening of the drain hole is thus suppressed and whistling is reduced or avoided.

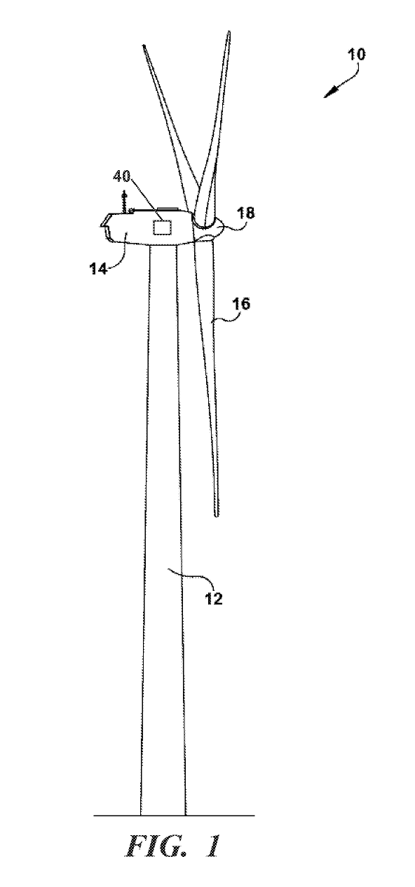

Referring now to the drawings, FIG. 1 illustrates a wind turbine 10 of conventional construction. The wind turbine 10 includes a tower 12 with a nacelle 14 mounted thereon. A plurality of turbine blades 16 are mounted to a rotor hub 18, which is in turn connected to a main flange that turns a main rotor shaft. The wind turbine power generation and control components are typically housed within the nacelle 14. For example, as shown, a controller 40 is provided within the nacelle 14 to control various wind turbine components. The view of FIG. 1 is provided for illustrative purposes only to place the present invention in an exemplary field of use. It should be appreciated that the invention is not limited to any particular type of wind turbine configuration.

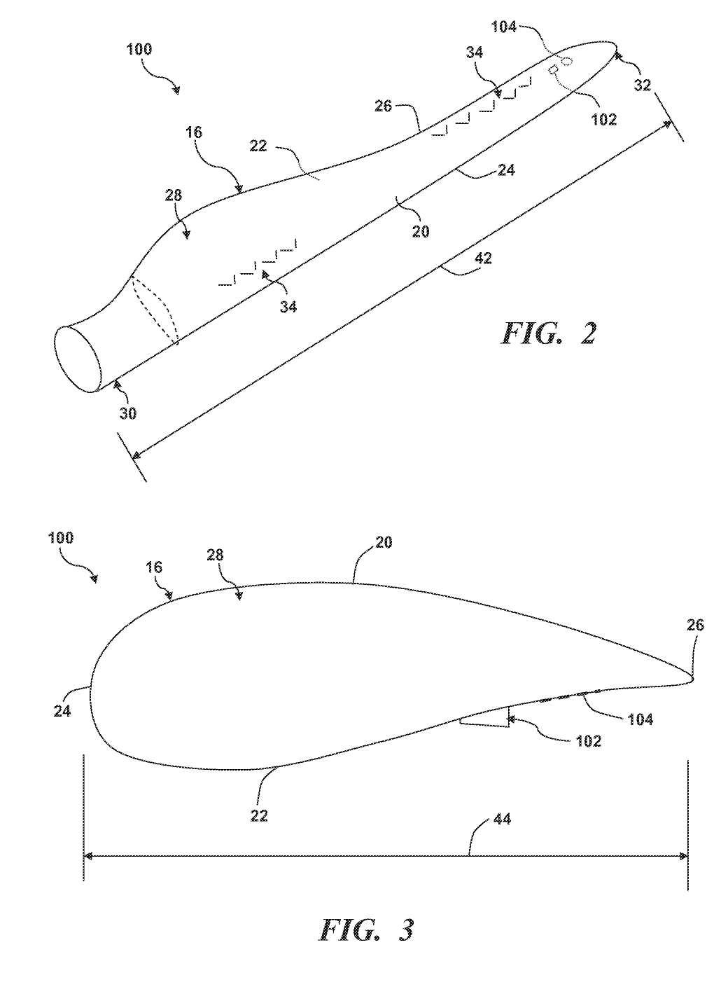

FIG. 2 depicts a rotor blade assembly 100 incorporating aspects of the invention. The rotor blade assembly 100 includes rotor blade 16 having a suction side surface 20, a pressure side surface 22, a leading edge 24, and a trailing edge 26. Further, the rotor blade 16 is defined by a body shell 28 extending from a blade root 30 to a blade tip 32. At least one airflow modifying element 102 in accordance with aspects of the invention described in greater detail below is formed on either of the pressure or suction surfaces 22, 24. In the embodiment illustrated in FIG. 2, the airflow modifying element 102 is depicted on the pressure side surface 22 for illustrative purposes only. It should be appreciated that the airflow modifying element 102 could also be provided on the suction side surface 20. More specifically, the airflow modifying element 102 may be placed at any location on either or both of the blade's flow surfaces 20, 22 wherein it is desired to reduce noise and/or whistling caused by a drain hole 104 configured within the body shell 28.

As mentioned, one or more drain holes 104 are typically provided in the body shell 28. Such drain holes 104 are important to wind turbine operation so as to provide draining of from within the body shell 28. Further, if a lightning strike occurs, water within the body shell 28 may heat up instantly into steam requiring substantially more volume. As such, the drain holes may also provide pressure-relief to the blade 16 such that the blade 16 is not damaged during operation.

Still referring to FIG. 2, the drain holes 104 are generally located at an outboard location, such as near the blade tip 32. Alternatively, the drain holes 104 may be provided at any location along a span 42 or chord 44 of the body shell 28 in either the pressure or suction sides 20, 22 or a tip edge surface. As such, the drain holes 104 may provide draining capabilities and pressure relief anywhere along the body shell 28. Typically, the drain holes 104 remain open; however, in some embodiments, it may be beneficial to provide removable covers (not shown). The cover may keep debris, water, or other contaminants from entering the body shell 28 during transportation, installation, and maintenance. Further, the cover may be in communication with the controller 40 such that it may be opened or closed during operation of the wind turbine 10.

Referring now to FIG. 3, the airflow modifying element 102 and drain hole 104 are illustrated on the pressure side surface 22 at a chord 44 length of between about 50% to about 75% as measured from the leading edge 24 of the rotor blade 16. More specifically, in one embodiment, the airflow modifying element 102 and drain hole 104 may be located at about 60% chord length as measured from the leading edge 24 of the rotor blade 16. Alternatively, the airflow modifying element 102 and drain hole 104 may be located less than 50% or more than 75% of the chord length as measured from the leading edge 24 of the rotor blade 16.

Additionally, the airflow modifying element 102 and drain hole 104 configuration may be disposed closer to the blade tip 32, as compared to the blade tip 32, as shown in FIG. 3, or may be closer to the blade tip 32 as compared to the blade root 30. It should be understood that the invention is not limited to any particular placement of the airflow modifying element 102 and drain hole 104 and the configuration may be located at any location on any of the flow surfaces of the rotor blade 16.

In regards to the location of the airflow modifying element 102 relative to the drain hole 104, the device is typically be placed upstream of the drain hole 104, which is theoretically perpendicular to the pitch axis (the axis that extends between the blade root and the blade tip). Thus, the airflow modifying element 102 is typically the same distance to blade root 30 and tip 32 as the drain hole 104. Practically, however, streamlines are slightly bended towards the blade tip 32 in the region of the drain hole 104. In such an embodiment, the airflow modifying element 102 should be placed closer to the blade root 30 than the drain hole 104, which may be referred to herein as the blade-root side. Alternatively, the airflow modifying element 102 may be placed closer to the blade tip 32 than the drain hole 104, or the blade-tip side.

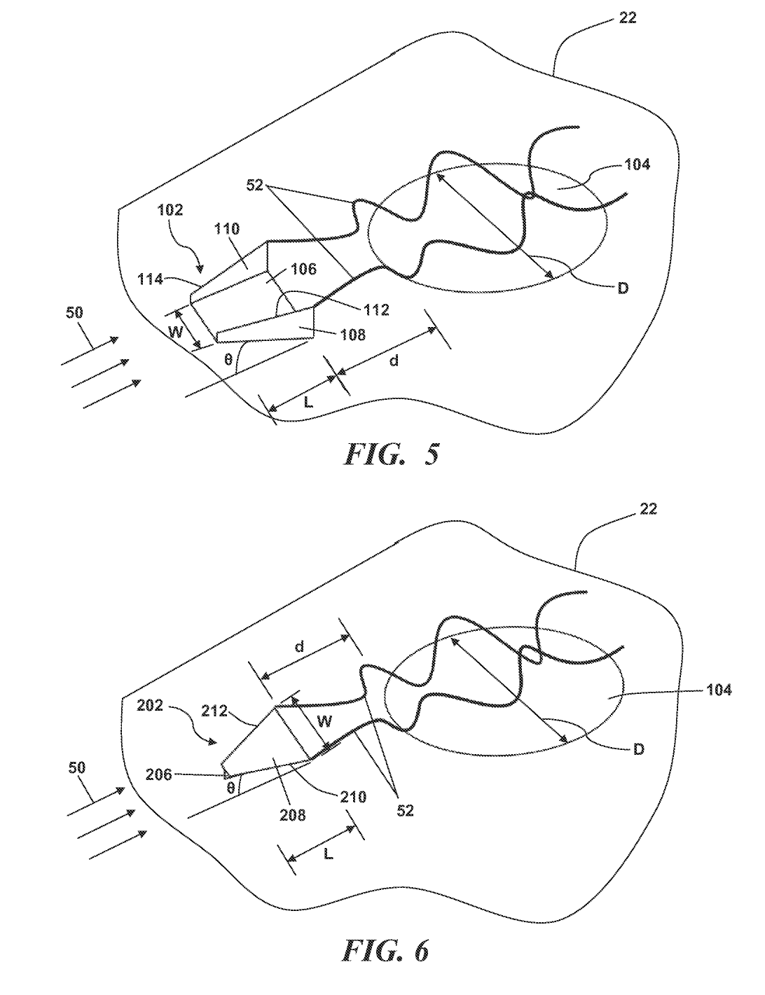

Referring to FIGS. 5 and 6, the drain hole 104 may have a diameter D. Further, the airflow modifying element 102 may be located a predetermined distance d from the drain hole 104. In one embodiment, the predetermined distance d may be approximately equal to the diameter D of the drain hole 104. In further embodiments, the predetermined distance d may be approximately half or less than half of the diameter D of the drain hole 104. In still further embodiments, the predetermined distance d may be equal to more than the diameter D of the drain hole 104. In one embodiment, the predetermined distance d may be approximately 10 millimeters (mm).

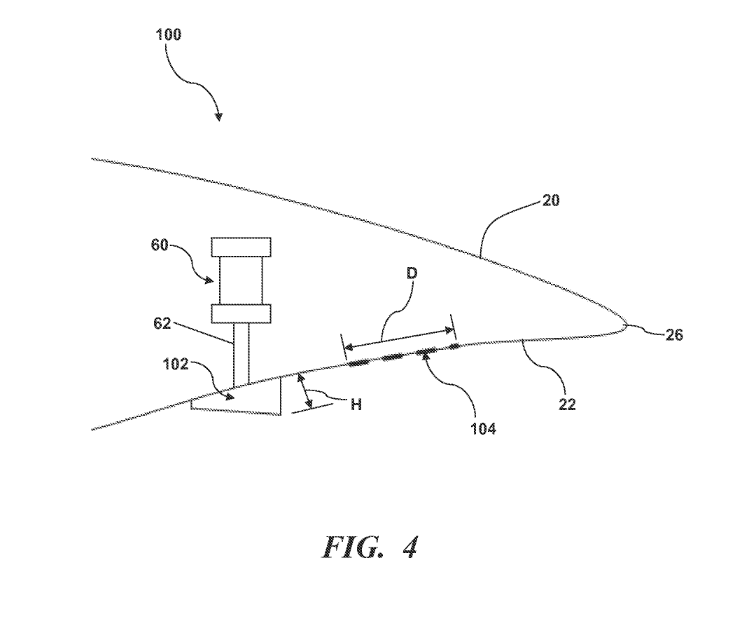

As particularly shown in FIG. 4, the airflow modifying element 102 may also extend a perpendicular distance from a surface (e.g. from the pressure side surface 22) of the blade 16 to define a maximum height H. Further, the maximum height H may be a function of a local boundary layer thickness. For example, the maximum height H may extend approximately 150% of the local boundary layer thickness. Further, the boundary layer thickness may depend on flow speed, angles of attack, and various other parameters. As used herein, the term “boundary layer thickness” is defined as an aerodynamically-determined distance from a surface of the body shell 28 to an undisturbed flow field above the surface of the body shell 28. Further, the term “local boundary layer thickness” is defined as the boundary layer thickness at or near the location of the drain hole and the airflow modifying element. Accordingly, the maximum height H may be dependent upon the location of the drain hole on the suction side, the pressure side, or at the side edge of the blade tip 32. More specifically, in one embodiment, the height H may be approximately 5 mm. In still further embodiments, the height H may be greater than 5 mm or less than 5 mm.

The airflow modifying element 100 may also define a width W and a length L as shown in FIGS. 5 and 6. The width W and length L are optimized so as to create appropriate vortices 52 over the drain hole 104, thereby reducing drain hole whistling. For example, in one embodiment, the width W may be approximately 10 mm and the length L may be approximately 15 mm, respectively. In further embodiments, the width may be greater than or less than 10 mm. Similarly, the length L may be greater than or less than 15 mm.

It should be understood that the airflow modifying elements 102, 202 described herein may have different shape configurations within the scope and spirit of the invention. For example, as shown in FIG. 5, the airflow modifying element 102 contains a base 106 having two sides 108, 110. The base 106 may be attached to the blade 16 using any suitable adhesive, such as tape or glue. Alternatively, the base 106 may be attached to an actuator 60 as will be described in further detail later. Further, the base 106 may have any suitable shape. For example, as shown, the base 106 may have a substantially trapezoidal shape wherein the sides 108, 110 define a skew angle θ with the flow direction 50. It should be understood that the skew angle θ may be any suitable angle ranging from 0 degrees to less than 90 degrees, more preferably about 40 degrees, more preferably about 30 degrees, still more preferably about 20 degrees. In further embodiments, the base may have a rectangular, square, triangular, circular, or similar shape.

The sides 108, 110 may also define any suitable shape having respective top edges 112, 114. Further, the respective top edges 112, 114 may have corresponding slopes that increase from a minimum height to a maximum height as the airflow modifying element 100 approaches the drain hole 104. For example, the minimum height may be approximately equal to the one half of the maximum height. Alternatively, the sloping edges 112, 114 may decrease from a maximum height to a minimum height as the airflow modifying element 100 approaches the drain hole 104. Further, the slopes of the edges 112, 114 may be different or may correspond with one another. In further embodiments, the sides 108, 110 may have flat, pointed, or arcuate edges.

In another embodiment, as shown in FIG. 6, the airflow modifying element 202 may have a base 206 and a top surface 208. The base 206 may be attached to the blade 16 using any suitable adhesive, such as tape or glue. Further, the base 206 may include feet (not shown) to assist in attaching the base 206 to one of the rotor blade surfaces 20, 22. In further embodiments, the base 206 may be attached to the actuator 60 as will be described in further detail later. As such, a slit of groove may be cut within the body shell 28 such that the base 206 may slide within the slit and the top surface 204 may lay substantially flush with the pressure side 22 when in a recessed position. Moreover, the base 206 may extend in generally the same direction as the flow direction 50.

The top surface 208 may define any suitable shape having respective edges 210, 212. For example, as shown, the top surface 208 may define a generally trapezoidal shape. As such, the respective edges 210, 212 may taper outwardly at a skew angle θ as the airflow modifying element 200 approaches the drain hole 104 (FIG. 6). Alternatively, the respective edges 210, 212 may taper inwardly at a skew angle θ as the edges 210, 212 approach the drain hole 104. In still further embodiments, the top surface 208 may have a rectangular, square, triangular, circular, or similar shape. As such, the respective edges may be parallel to one another, may diverge with one other, or may have an arcuate shape. Further, the slopes of the edges 210, 212 may be different or may correspond with one another.

In still further embodiments, the airflow modifying elements 102, 202 may be any suitable shape known in the art. For example, the airflow modifying elements 102, 202 may be shaped like conventional vortex generators, including fin or wedge-type shapes. The descriptions of the shapes of the airflow modifying elements 102, 202 described herein are not meant to be limiting and are provided for illustrative purposes only.

The relationship of the dimensions of the airflow modifying element 102 as described herein (i.e. predetermined distance d, drain-hole diameter D, height H, width W, length L, and skew angle θ) and the location of airflow modifying element with respect to the drain hole both contribute to the reduction in drain-hole whistling and/or noise in surrounding areas. More specifically, as illustrated in FIGS. 5 and 6, the incoming air stream 50 is modified by the airflow modifying elements 102, 202 such that the airstream after the airflow modifying elements 102, 202 forms two counter-rotating vortices 52 that flow over the drain hole 104. Further, the airflow modifying elements 102, 202 enhance mixing of higher energetic flows in the outer boundary layer with lower energetic flows in the inner boundary layer and form the counter-rotating vortices 52 which are oriented in the flow direction. As such, the vortices 52 above the drain hole 104 stabilize the shear layer at the opening of the drain hole 104. Accordingly, the resonating interaction of the mass within the drain hole (e.g. water within the blade) with the shear layer at the opening of the drain hole is thus suppressed and whistling is reduced or avoided.

As mentioned and referring back to FIG. 3, each airflow modifying element 102 may be coupled to an actuator 60 disposed within the rotor blade 16. In general, the actuator 60 may be configured to displace the airflow modifying element 102 between a recessed position (i.e. within the blade shell) to an actuated position (i.e. above the blade shell). Accordingly, it should be appreciated that the actuator 60 may generally comprise any suitable device capable of moving the airflow modifying element 102 relative to the shell 28. For example, in several embodiments, the actuator 60 may comprise a linear displacement device configured to linearly displace the airflow modifying element 102 between the actuated and recessed positions. In the context of the present subject matter, the term “linearly displace” refers to the displacement of a surface feature along a straight line. Thus, in one embodiment, the actuator 60 may comprise a hydraulic, pneumatic or any other suitable type of cylinder configured to linearly displace a piston rod 62. Thus, as shown, the airflow modifying element 102 may be attached to the piston rod 62 such that, as the piston rod 62 is actuated, the airflow modifying element 102 is linearly displaced relative to the shell 28. In other embodiments, the actuator 60 may comprise any other suitable linear displacement device, such as a rack and pinion, a worm gear driven device, a cam actuated device, an electro-magnetic solenoid or motor, other electro-magnetically actuated devices, a scotch yoke mechanism and/or any other suitable device. Alternatively, the airflow modifying elements 102, 200 may be affixed to the body shell 28 such that they remain in place and are not actuated between a recessed and an actuated position.

The airflow modifying elements 102, 202 and associated drain hole 104 may also be in communication with the controller 40 housed within the nacelle 14 (FIG. 1). More specifically, the controller 40 may be supplied with control signals in response to the respective wind or other conditions experienced by the individual blade 16 (i.e. increased water or pressure within the blade 16) as detected by any manner of sensor provided in or around the blade 16. As such, the one or more sensors may supply a signal to the controller 40 for near-instantaneous control of the airflow modifying elements 102, 200 and/or drain hole(s) 36 associated with each of the respective blades 16. For example, the controller 40 may send one or more signals to the actuator 60 that may move the airflow modifying elements 102, 202 from the recessed to the actuated position. Further, the drain hole 104 may include a cover that moves between an open position and a closed position. As such, the controller 40 may send signals to the drain hole 104 so as to move the cover between the open and closed positions. Accordingly, in one embodiment, the airflow modifying element 102 may move from the recessed position to the actuated position so as to reduce noise associated with an open drain hole 104.

In another embodiment, a method for reducing airflow noise caused by one or more drain holes of a wind turbine is disclosed. The method may include measuring an airflow noise near the wind turbine using one or more sensors. The sensors may be configured to detect a decibel value caused by the drain hole. The airflow noise (e.g. the decibel value) may then be provided to the controller 40. As such, the controller 40 may be configured to actuate one or more airflow modifying element when the airflow noise (or decibel value) exceeds a predetermined threshold. Further, actuating the airflow modifying element may be completed as a function of the decibel value. In addition, the airflow modifying element may be located a predetermined distance from the drain hole. Moreover, the predetermined distance may be equal to or less than the diameter of the drain hole. Accordingly, the method as described herein reduces the airflow noise caused by the drain hole when the airflow modifying element is in an actuated position.

In another embodiment, the method may also include actuating the airflow modifying element to a maximum height. As mentioned, the maximum height is typically a perpendicular distance from a surface of the blade. Further, the maximum height may be equal to or less than half of the diameter of the drain hole.

In still further embodiments, the blade 16 may incorporate the airflow modifying elements 102, 202 and drain-hole configuration 36 described herein with conventional aerodynamic vortex generators 34. For example, as depicted in FIG. 2, the airflow modifying elements 102, 200 may be provided at a defined region of the blade 16 near the drain hole 104, while the conventional vortex generators 34 may be provided at a different region of the blade 16. In a particular embodiment, the airflow modifying elements 102, 202 may be configured on the pressure side 22 at the blade tip 32 of the rotor blade 16 (as shown in FIG. 2), while conventional wedge or fin-type vortex generators 34 may be provided on the suction side of the blade 16, or both the pressure and suction sides 20, 22. In an alternate embodiment, the airflow modifying elements 102, 202 may be located closer to the blade tip 32 than the blade root 30.

It should also be understood that the present invention encompasses any configuration of the wind turbine 10 (FIG. 1) that includes one or more rotor blade assemblies 100 incorporating at least one of the unique airflow modifying elements 102, 202 and drain holes 104 as described herein.

While the present subject matter has been described in detail with respect to specific exemplary embodiments and methods thereof, it will be appreciated that those skilled in the art, upon attaining an understanding of the foregoing, may readily produce alterations to, variations of, and equivalents to such embodiments. As mentioned, it should also be appreciated that the invention is applicable to any type of flow surface, and is not limited to a wind turbine blade. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A rotor blade assembly for a wind turbine, the rotor blade assembly comprising:
at least one rotor blade including a body shell extending between a blade root and a blade tip, the body shell defining a pressure side surface and a suction side surface;
at least one drain hole having a diameter, the drain hole configured within the body shell;
at least one airflow modifying element configured on the body shell, the airflow modifying element located a predetermined distance from the drain hole such that the airflow modifying element reduces airflow noise caused by the drain hole, the predetermined distance equal to or less than the diameter of the drain hole.

2. The rotor blade assembly of claim 1, wherein the airflow modifying element extends a perpendicular distance from a surface of the blade to define a maximum height, the maximum height being a function of a local boundary layer thickness.

3. The rotor blade assembly of claim 2, wherein the maximum height extends approximately 150% of the local boundary layer thickness.

4. The rotor blade assembly of claim 3, wherein the airflow modifying element has a base, a first side, and a second side, the first and second sides defining respective top edges.

5. The rotor blade assembly of claim 5, wherein the respective top edges have corresponding slopes that increase upwardly above the surface of the rotor blade to the maximum height.

6. The rotor blade assembly of claim 1, wherein the airflow modifying element has a base and a top surface, the base connected to the pressure side surface, the top surface having respective edges, the edges having corresponding slopes that increase outwardly to a maximum width.

7. The rotor blade assembly of claim 1, wherein the drain hole and the airflow modifying element are defined on the pressure side surface at a chord length of between about 50% to about 75% as measured from a leading edge of the rotor blade.

8. The rotor blade assembly of claim 7, wherein the airflow modifying element is located on a blade-root side of the drain hole.

9. The rotor blade assembly of claim 1, wherein the airflow modifying element and the drain hole are closer to the blade tip of the rotor blade as compared to the blade root.

10. The rotor blade assembly of claim 1, further comprising an actuator coupled to the at least one airflow modifying element.

11. The rotor blade assembly of claim 11, wherein the plurality of airflow modifying elements are formed on the suction side surface and the pressure side surface of the rotor blade.

12. The rotor blade assembly of claim 11, wherein each airflow modifying element is positioned a predetermined distance from a different drain hole.

13. A rotor blade assembly for a wind turbine, the rotor blade assembly comprising:
at least one rotor blade having a suction side surface and a pressure side surface;
a drain hole configured on the pressure side surface;
at least one airflow modifying element configured on the pressure side surface, the airflow modifying element located a predetermined distance from the drain hole such that the airflow modifying element reduces airflow noise caused by the drain hole, the airflow modifying element extending a perpendicular distance from the pressure side surface of the blade to define a maximum height, the maximum height being a function of a boundary layer thickness.

14. The rotor blade assembly of claim 13, wherein the predetermined distance is equal to or less than the diameter of the drain hole.

15. The rotor blade assembly of claim 13, wherein the airflow modifying element has a base, a first side, and a second side, the first and second sides defining respective top edges, the respective top edges having corresponding slopes that increase to a maximum height above the pressure side surface of the rotor blade.

16. The rotor blade assembly of claim 13, wherein the airflow modifying element has a base and a top surface, the base connected to the pressure side surface, the top surface having opposite edges, the edges having corresponding slopes that increase to a maximum width towards the at least one drain hole.

17. The rotor blade assembly of claim 13, wherein the drain hole and the airflow modifying element are defined on the pressure side surface at a chord length of between about 50% to about 75% as measured from a leading edge of the rotor blade.

18. A method for reducing airflow noise caused by a drain hole of a wind turbine, said method comprising:
monitoring an airflow noise near a wind turbine;
providing the monitored airflow noise to a controller; and,
actuating an airflow modifying element, by the controller, when the airflow noise exceeds a predetermined threshold, the airflow modifying element located a predetermined distance from the drain hole so as to reduce
the airflow noise caused by the drain hole when the airflow modifying element is in an actuated position.

19. The method of claim 18, wherein monitoring the airflow noise near the wind turbine further comprises measuring a decibel value of the airflow noise and actuating the airflow modifying element as a function of the decibel value.

20. The method of claim 18, further comprising actuating the airflow modifying element to a maximum height, the maximum height being a perpendicular distance from a surface of the blade, the maximum height equal to or less than half of the diameter of the drain hole.
